(19) United States
(12) Patent Application Publication
(10) Pub. No.: US 2014/0172642 A1
(43) Pub. Date: Jun. 19, 2014

(54) ANALYZING COMMODITY EVALUATIONS

(71) Applicant: Alibaba Group Holding Limited, George Town (KY)

(72) Inventor: Yan Zhang, Hangzhou (CN)

(21) Appl. No.: 14/102,353

(22) Filed: Dec. 10, 2013

(30) Foreign Application Priority Data
Dec. 13, 2012 (CN) 201210540338.7

(51) Int. Cl. G06Q 30/06

(52) U.S. Cl. CPC G06Q 30/0625
USPC 705/26.62

(57) ABSTRACT

Analyzing commodity evaluations includes: receiving a commodity evaluation analysis request including information associated with a commodity; obtaining commodity evaluation information associated with the information associated with the commodity of the commodity evaluation analysis request; dividing the commodity evaluation information into a plurality of sentences; comparing a sentence of the plurality of sentences against a stored commodity word bank, wherein the commodity word bank includes a plurality of preset commodity evaluation keywords; including a phrase of the sentence that matches an entry of the commodity word bank in a set of successfully matched commodity evaluation keywords; and providing the set of successfully matched commodity evaluation keywords to a user interface.

### CROSS REFERENCE TO OTHER APPLICATIONS

This application claims priority to People's Republic of China Patent Application No. 201210540338.7 entitled ELECTRONIC INFORMATION-BASED KEYWORD-EXTRACTION INFORMATION-PUSHING AND SEARCHING METHOD AND DEVICE, filed Dec. 13, 2012 which is incorporated herein by reference for all purposes.

### FIELD OF THE INVENTION

The present application relates to the technical field of text analysis. In particular, it relates to commodity evaluation information analysis.

### BACKGROUND OF THE INVENTION

In the present information age, more and more information is appearing in electronic form. For example, as the Internet develops rapidly, more and more people are beginning to post opinions online. Thus, a large volume of opinions and commentaries have appeared on the Internet. In some instances, people may wish to consume some of this user-submitted electronic information during their decision making.

For example, prior to purchasing products, people may wish to research whether other people have given the products good evaluations. For example, consumers-to-consumers (C2C) and business-to-consumers (B2C) e-commerce websites may set up evaluation systems that enable buyer users to manually evaluate sellers regarding each transaction. In a first example, after a buyer and seller complete a transaction, the buyer may select an evaluation parameter value from among the preset options of “Positive,” “Neutral,” and “Negative” provided by the evaluation system to rate the seller and/or transaction. In addition or alternative to selecting one among multiple evaluation parameters, the buyer may give a text-based evaluative description of the product, such as, for example “The boots were of a high quality.”

In a second example, the buyer may assign a score for each of various aspects of the transaction (e.g., commodity quality, seller attitude, delivery speed, etc.) and an evaluation parameter value (“Positive,” “Neutral,” or “Negative”) that is preset to correspond to each particular range of scores is determined for the aspect of the transaction. In addition or alternative to assigning a score to each aspect of the transaction, the buyer may give a text-based evaluative description of the product.

Such conventional techniques by which buyers manually conduct evaluations have given rise to several different problems. One such problem is that a single product evaluation may include inconsistent information. For example, a buyer may rate a particular transaction with a positive evaluation parameter value (“Positive”) but then include negative opinions in the text-based evaluative description portion of the same product review.

Furthermore, many online articles and/or reviews purport to evaluate or explain a product. Examples of such articles include reports written by authors who have used a product on a trial basis and user reviews posted at discussion forums. Each of these articles and/or reviews expresses a viewpoint of the author regarding a product. These viewpoints regarding a product may include positive support, negative opposition, or neutral feedback. Some of these articles and/or reviews directly indicate the author's opinion, such as approval or disapproval, of the product. Yet the majority of articles, such as blogs, journals, and reports do not directly state the author's viewpoints. However, the viewpoints in these articles and/or reviews are often the most objective or informative opinions to potential buyers because it is presumed that the authors of such evaluations have a professional duty to provide objective reporting.

As described above, product evaluations submitted by buyers at commerce websites may not be reliable or objective. It is also unrealistic for potential buyers to read all the articles and/or reviews regarding a product that are available on the Internet. In some systems, the existence of buyer submitted evaluation parameters will even affect the accuracy of search results. For example, the ranking of certain defective commodities are not affected by content of their text-based evaluative descriptions but due to their inaccurate positive evaluation parameters, such defective commodities may end up being ranked at the top of the search results together as commodity information associated with relatively high quality/relevancy to a user's search request. As a result, the user needs to expend time and energy to pore through search results and may even need to conduct new searches. Not only do these repeated searches add to the load on servers but they also waste network resources.

### BRIEF DESCRIPTION OF THE DRAWINGS

Various embodiments of the invention are disclosed in the following detailed description and the accompanying drawings.

FIG. 1 is a diagram showing an embodiment of a system for analyzing commodity evaluations.

FIG. 2 is a flow diagram showing an embodiment of a process for analyzing commodity evaluations.

FIG. 3 is a flow diagram showing an example process of determining a set of successfully matched commodity evaluation keywords.

FIG. 4 is a flow diagram showing an embodiment of a process for analyzing commodity evaluations.

FIG. 5 is a flow diagram showing an embodiment of a process for analyzing commodity evaluations.

FIG. 6 is a flow diagram showing an embodiment of a process for analyzing commodity evaluations.

FIG. 7 is a flow diagram showing an embodiment of a process for performing a search for a commodity.

FIG. 8 is a diagram showing an embodiment of a system for analyzing commodity evaluations.

FIG. 9 is a diagram showing an embodiment of a system for analyzing commodity evaluations.

FIG. 10 is a diagram showing an embodiment of a system for performing a search of commodities.

FIG. 11 is a diagram showing an embodiment of a system for receiving commodity evaluation analysis results.

FIG. 12 is a diagram showing an example of a user interface displaying information associated with a commodity.

FIG. 13 is a diagram showing an example of a user interface displaying a set of successfully matched commodity evaluation keywords and their respective evaluation parameter values.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of analyzing commodity evaluations are described herein. In some embodiments, a commodity evaluation analysis request is received. For example, the commodity evaluation analysis request includes information identifying one or more commodities. In various embodiments, a “commodity” refers to a product, service, virtual good, and anything else of value or utility. Commodity evaluation information, which includes evaluations related to the commodity (or commodities) identified in the request, is obtained. The obtained commodity evaluation information is divided into sentences and each sentence is compared to one or more preset commodity word banks that include various preset commodity evaluation keywords. In various embodiments, a “commodity evaluation keyword” refers to a preset descriptive phrase of a commodity. For example, “high-quality,” “long battery life,” and “average” may be preset commodity evaluation keywords for a commodity. A commodity evaluation keyword may express an opinion/evaluation/degree of recommendation by the author of the sentence with respect to at least one aspect of a commodity. Those phrases of the sentences that are determined to match preset commodity evaluation keywords of the commodity word banks are determined to be successfully matched commodity evaluation keywords. In some embodiments, each set of successfully matched commodity evaluation keywords is presented at a user interface.

In some embodiments, one or more preset commodity evaluation keyword banks store mappings between commodity evaluation keywords and corresponding preset evaluation parameter values. In various embodiments, any number of different evaluation parameter values may be preset, where each evaluation parameter value corresponds to a different degree of recommendation of a commodity. For example, three possible evaluation parameter values may be set: “Positive,” “Neutral,” and “Negative.” Thus, in some embodiments, for each successfully matched commodity evaluation keyword, the corresponding evaluation parameter value is determined from the stored mappings in the commodity word banks A count of each type of evaluation parameter value corresponding to the set of successfully matched evaluation keywords for a particular commodity is determined (e.g., 10 Positives, 15 Neutrals, 5 Negatives) and a display including each type of evaluation parameter and a value determined based on its corresponding count is presented for the user at the user interface.

In some embodiments, a search ranking may be determined for a particular commodity based on the evaluation parameter values corresponding to the set of successfully matched evaluation keywords for that commodity in the event that the commodity is determined to be responsive to a commodity search request.

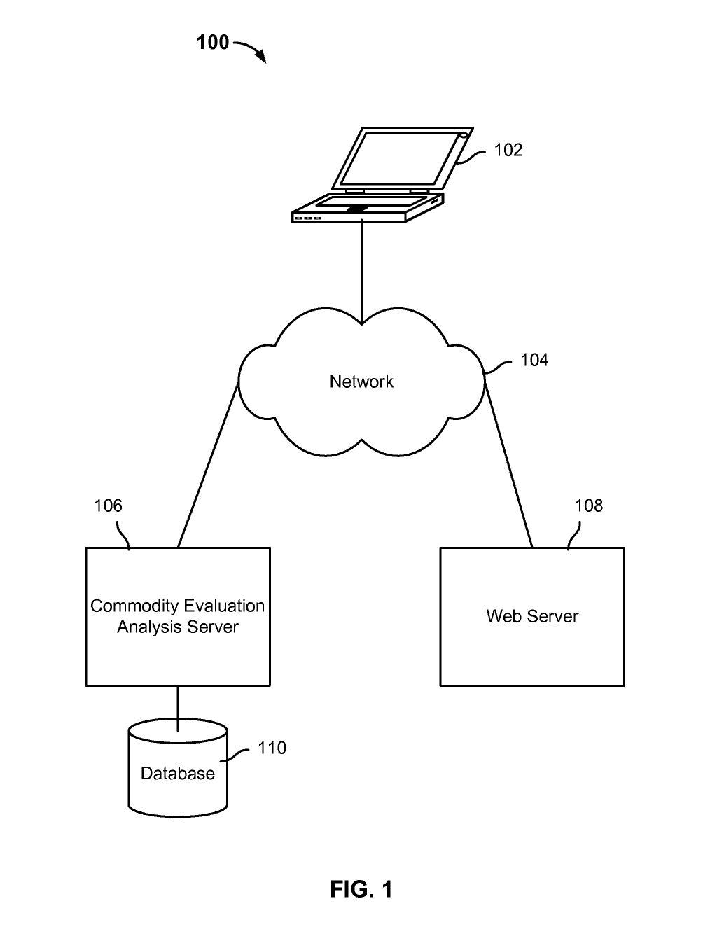

FIG. 1 is a diagram showing an embodiment of a system for analyzing commodity evaluations. In the example, system 100 includes client device 102, network 104, commodity evaluation analysis server 106, web server 108, and database 110. Network 104 includes high-speed data networks and/or telecommunications networks. Client device 102, commodity evaluation analysis server 106, and web server 108 may communicate to each other over network 104. In some embodiments, web server 108 and commodity evaluation analysis server 106 are operated by the same party.

Web server 108 is configured to operate a website. In various embodiments, the website comprises an electronic commerce website on which commodities are available for sale. Commodity evaluation analysis server 106 is configured to receive a commodity evaluation analysis request from either web server 108 or from client device 102. The commodity evaluation analysis request may include information identifying one or more commodities for which relevant commodity evaluation information is to be analyzed by commodity evaluation analysis server 106. For example, a commodity evaluation analysis request may be generated in response to a selection at the website by a user using client device 102. In response to the commodity evaluation analysis request, commodity evaluation analysis server 106 is configured to obtain commodity evaluation information (e.g., product reviews, consumer reports) related to the commodity (or commodities) identified in the commodity evaluation analysis request from a database, such as database 110, for example. As will be described in detail below, in some embodiments, commodity evaluation analysis server 106 is configured to send to client device 102 a set of successfully matched commodity evaluation keywords that comprise preset phrases selected from the obtained commodity evaluation information that are descriptive of the commodity identified in the commodity evaluation analysis request. In some embodiments, in addition or alternative to sending the set of successfully matched commodity evaluation keywords to client device 102, commodity evaluation analysis server 106 is configured to send to client device 102 a set of evaluation parameter values corresponding to respective ones of the set of successfully matched commodity evaluation keywords. An evaluation parameter value (e.g., “Positive,” “Neutral,” or “Negative”) corresponding to a commodity evaluation keyword represents a degree of recommendation of the commodity by the author of the commodity evaluation keyword. As will be described in detail below, in some embodiments, commodity evaluation analysis server 106 is configured to send the determined proportion of each evaluation parameter value relative to all evaluation parameter values of the set of evaluation parameter values corresponding to ones of the set of successfully matched commodity evaluation keywords to client device 102.

In some embodiments, client device 102 is configured to display the set of successfully matched commodity evaluation keywords and/or information (e.g., proportions) associated with the set of evaluation parameter values associated with a commodity at a user interface. By presenting the set of successfully matched commodity evaluation keywords and/or information (e.g., proportions) associated with the set of evaluation parameter values to a user, the user may be able to consume a simple summary of key evaluation information about the commodity determined from the obtained commodity evaluation information without needing to manually review each piece of the commodity evaluation information.

In some embodiments, commodity evaluation analysis server 106 is configured to send the set of successfully matched commodity evaluation keywords and/or information (e.g., proportions) associated with the set of evaluation parameter values associated with a commodity to web server 108. When a user wishes to search for commodities to potentially purchase, the user may use client device 102 to send a commodity search request (e.g., via a search engine associated with the website) to web server 108. As will be described in further detail below, in some embodiments, web server 108 is configured to use the set of successfully matched commodity evaluation keywords and/or information (e.g., proportions) associated with the set of evaluation parameter values associated with a commodity that matches the commodity search request to determine a ranking of the commodity among search results. Web server 108 is configured to send the ranked commodity search results to client device 102, which will present the ranked commodity search results at a user interface for the user to view.

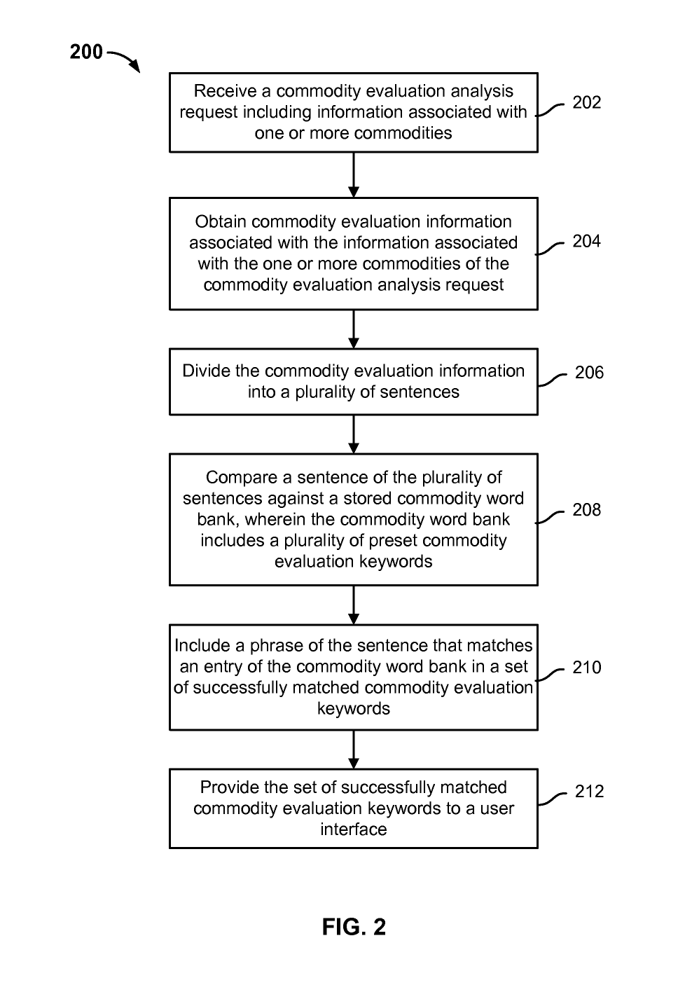

FIG. 2 is a flow diagram showing an embodiment of a process for analyzing commodity evaluations. In some embodiments, process 200 is implemented at system 100 of FIG. 1.

At 202, a commodity evaluation analysis request including information associated with one or more commodities is received.

The commodity evaluation analysis request includes keywords and/or other information identifying one or more commodities. In some embodiments, a commodity evaluation analysis request may be generated by a user selection of a control associated with generating a commodity evaluation analysis request, a user submission of keywords, and/or a computer program. For example, in the context of electronic commerce (e-commerce), a “Commodity Evaluation” button may be displayed at a webpage associated with a particular commodity such that in response to a user selection of the button, a commodity evaluation analysis request including identifying information associated with the commodity associated with the webpage is generated. In another example, each time that a commodity's webpage is requested by a user, it may be desirable to display the commodity evaluation keywords associated with that commodity and thus a commodity evaluation analysis request including identifying information associated with the commodity associated with the webpage is programmatically generated prior to displaying the contents of the webpage. In yet another example, in response to a user's commodity search request, as will be described further below, a commodity evaluation analysis request including identifying information associated with each commodity that matches the commodity search request is programmatically generated to help determine the ranking of the matching commodities to be displayed on the search results web page.

An example piece of information to include in a commodity evaluation analysis request is the keyword “Acme brand flashlight.”

At 204, commodity evaluation information associated with the information associated with the one or more commodities of the commodity evaluation analysis request is obtained.

In various embodiments, “commodity evaluation information” refers to any document that may be automatically processed and evaluates, analyzes, or describes a commodity. Examples of commodity evaluation information include, but are not limited to: commodity evaluation information, commodity review content, reports or articles written about a trial use of a commodity, commodity use review reports or articles, and commodity forum discussion content.

In some embodiments, one or more designated databases and/or other sources may be searched for commodity evaluation information relevant to the information included in the commodity evaluation analysis request. Designated databases may comprise databases associated with one or more websites, for example.

Below are two example modes by which to obtain commodity evaluation information associated with the information included in a commodity evaluation analysis request:

Mode 1: Search one or more designated databases for commodity evaluation information that is relevant to the information included in a commodity evaluation analysis request.

For example, some websites set up forum databases that are configured to store the content and information of user discussions and evaluations associated with some commodities. In another example, some websites set up review databases that are configured to store evaluation information submitted by users on commodities that they have purchased. In performing directional collecting, the designated databases to use for searching may be identified based on corresponding locations of the databases. Thus, commodity evaluation information of the designated databases that match the information included in a commodity evaluation analysis request can be obtained.

Mode 2: Use a web crawler to obtain commodity evaluation information that is relevant to information included in a commodity evaluation analysis request.

A web crawler usually searches for web pages via web page links. Starting with a page (generally the home page) at a website, a web crawler reads the web page contents, finds other links included in the web page, and then looks for subsequent web pages to review using these links. The web crawler may repeat these steps until it captures all the web pages of a particular website, for example. For example, keywords may be determined, such as from the information included in a commodity evaluation analysis request, and submitted to a search engine that uses web crawler technology. Then, commodity evaluation information may be obtained from the search results previously accessed by the web crawler and returned by the search engine.

The two modes of obtaining commodity evaluation information relevant to information included in a commodity evaluation analysis request are merely examples and other techniques to use to obtain relevant commodity evaluation information may be used as well. For example, search engines may be used to search for commodity review articles through keywords associated with information included in a commodity evaluation analysis request. The search engine may return some articles that have more clear-cut viewpoints and that meet pre-established formatting and content requirements. For example, these articles may include review reports or articles written about trial uses of commodities. Since some of these trial use review report articles may have clear-cut viewpoints and meet definite formatting and content requirements, the analysis of this type of article is presumed to be much more accurate than certain other types of articles. In some instances, trial use review report articles generally use phrases that are more clearly defined and scientific. Examples of such phrases may relate to colors, performance, flavor, price, and other attributes that describe a commodity. Such trial use review report articles may be one of several different types of commodity evaluation information to be analyzed.

At 206, the commodity evaluation information is divided into a plurality of sentences.

Conventionally, textual analysis is performed using word segmentation. Typically, word segmentation entails decomposing an article (e.g., a review) into words according to existing word banks and then extracting the adjectives from the segmented words. However, segmenting an article into individual words may not be effective in analyzing the commodity evaluation of the article if the word segmentation is not performed all together accurately.

In contrast to using word segmentation, various embodiments as described herein divide commodity evaluation information into sentences. For example, the obtained commodity evaluation information is divided at punctuation marks (e.g., such as periods, question marks, exclamation marks, etc.), which are regarded as splitting points, into a plurality of sentences. Splitting out sentences preserves the sequence and also the context of words in their original sentences and may serve to improve the accuracy of extracting commodity evaluation keywords from the sentences.

In some embodiments, each sentence extracted from the obtained commodity evaluation information is stored.

At 208, a sentence of the plurality of sentences is compared against a stored commodity word bank, wherein the commodity word bank includes a plurality of preset commodity evaluation keywords.

At 210, a phrase of the sentence that matches an entry of the commodity word bank is included in a set of successfully matched commodity evaluation keywords.

Steps 208 and 210 may be repeated for each sentence of the plurality of sentences in the commodity evaluation information obtained for the commodity evaluation analysis request.

Different commodities may be associated with different types of attributes. For example, a commodity of a piece of clothing may be associated with the attribute of material (e.g., cashmere, cotton, or wool) and a commodity of a mobile device may be associated with battery life (e.g., 5 hours, 8 hours, or 10 hours). Because the types of attributes of different commodities are different, in some embodiments, a different commodity word bank is pre-established for each category of commodities. In some embodiments, if there are multiple hierarchies of commodity categories (e.g., as used by an e-commerce website), then a commodity word bank may be established for each category at each level of the hierarchy. The commodity word bank corresponding to a particular commodity category (e.g., at the category's corresponding level in the hierarchy of the category) includes entries that comprise various predetermined commodity evaluation keywords that describe common attributes that are specific to that category.

In some embodiments, a hierarchy of categories includes at least three levels. The first level is at the top of the hierarchy, which is also sometimes referred to as level 1, and includes main commodity categories. Main commodity categories comprise the most general categories. The second level from the top of the hierarchy, which is also sometimes referred to as level 2, includes sub-categories. A sub-category is narrower than its corresponding main category. A main commodity category at level 1 may correspond to zero or more sub-categories at level 2. The third or even further level from the top of the hierarchy, which is also sometimes respectively referred to as level 3 or greater, includes subordinate categories. A subordinate category is narrower than its corresponding subcategory. A sub-category at level 2 may correspond to zero or more subordinate categories at level 3 and a subordinate category at level 3 may correspond to zero or more subordinate categories at level 4, and so forth.

In some embodiments, a commodity word bank is preset for each commodity category at each level of the hierarchy. For example, a commodity word bank is preset for each main commodity category at level 1, each sub-category at level 2, each subordinate category at level 3, and so forth.

For example, a level 1 commodity word bank associated with the main commodity category of “electric appliance commodities” may include commodity evaluation keywords that describe power, electrical consumption, operating voltage, and other such attributes associated with commodities in the main commodity category of “electric appliance commodities.” In another example, a level 1 commodity word bank associated with the main commodity category of “food” may include commodity evaluation keywords that describe color, texture, flavor, and other such attributes associated with commodities in the main commodity category of “food.” For example, the commodity evaluation keywords relating to the attribute of “flavor” may include “sweet,” sour,” and “salty.”

In some embodiments, and as will be further described below, each entry in a commodity word bank also includes a mapping to a corresponding evaluation parameter value for a commodity evaluation keyword. For example, a set of various evaluation parameter values may be preset. Each evaluation parameter value of the set is associated with a different degree of recommendation of a commodity by an author of the corresponding commodity evaluation keyword. For example, the following three possible evaluation parameter values may be set: “Positive,” “Neutral,” and “Negative.” For example, a commodity evaluation keyword of “delicious” may be mapped to the evaluation parameter value of “Positive,” the commodity evaluation keyword of “satisfying” may be mapped to the evaluation parameter value of “Neutral,” and the commodity evaluation keyword of “inedible” may be mapped to the evaluation parameter value of “Negative.”

In some embodiments, prior to performing process 200, a level 1 commodity word bank corresponding to each different main commodity category is established. Level 1 commodity word banks include commodity evaluation keywords corresponding to main commodity categories. For example, a level 1 commodity word bank is set up for the main commodity category of “wristwatches.” This word bank corresponding to the main commodity category of “wristwatches” would include commodity evaluation keywords corresponding to commodities related to wristwatches. In various embodiments, “commodity evaluation keywords” of a particular category of commodities refer to words descriptive of the common attributes of that category. A level 2 commodity measure word bank corresponding to each different sub-category under a main commodity category is also established. Level 2 commodity word banks include commodity evaluation keywords corresponding to commodity sub-categories. For example, the two sub-categories of “electronic watches” and “mechanical watches” may be included under the main commodity category of “wristwatches.” Thus, a level 2 commodity word bank would be established for each of the two sub-categories of “electronic watches” and “mechanical watches.” Each of “electronic watches” and “mechanical watches” word banks would include commodity evaluation keywords that describe various common attributes of the respective sub-category. In some embodiments, the commodity evaluation words that are shared by both sub-categories of “electronic watches” and “mechanical watches” would already be included in the level 1 commodity word bank of the main commodity category “wristwatch” to which the sub-categories belong. By including commodity evaluation keywords common to sub-categories in the main commodity category commodity word bank and by excluding these commodity evaluation keywords common to sub-categories from the commodity word banks of the sub-categories, storage space may be conserved. The same principle may apply to the commodity word banks of sub-categories and their respective subordinate categories.

If there are further subordinate categories under the sub-categories, a commodity word bank corresponding to each such subordinate category under a sub-category is established. For example, assume that for the main commodity category of “food,” there is the sub-category of “beverages.” Under the sub-category of “beverages,” there is the subordinate category of “carbonated beverages.” Thus, the appropriate commodity evaluation keywords that describe the attributes of “food” (e.g., attributes that are common to all categories under the main commodity category of “food” in the hierarchy) are included in a level 1 commodity word bank. The appropriate commodity evaluation keywords that describe the attributes of “beverages” (e.g., attributes that are common to all categories under the sub-category of “beverages” in the hierarchy) are included in a level 2 commodity word bank. The appropriate commodity evaluation keywords that describe the attributes of “carbonated beverage” (e.g., attributes that are common to all categories under the subordinate category of “beverages” in the hierarchy) are included in a level 3 commodity word bank.

In some embodiments, commodity word banks may be updated (e.g., by a system administrator) in real-time or at fixed intervals. Updating a commodity word bank may include modifying existing commodity evaluation keywords, adding new commodity evaluation keywords, deleting existing commodity evaluation keywords, and/or modifying the evaluation parameter values corresponding to commodity evaluation keywords. As commodity evaluation keywords are continually added to commodity word banks, more commodity evaluation keywords will be available to potentially match the content of the sentences within the obtained commodity evaluation information.

The established commodity word banks may be used to match against each sentence extracted from the obtained commodity evaluation information. For example, a stored sentence may be considered at a time where all the commodity evaluation keywords stored in a commodity word bank are compared against the phrases of the sentence to determine whether a commodity evaluation keyword of the word bank matches any phrase included in the sentence. In the event that a match is found, that matching commodity evaluation keyword is considered to be a successfully matched commodity evaluation keyword. In some embodiments, matching includes both identical matches and also substantially similar matches. If there is more than one commodity word bank, then each relevant commodity word bank is matched to the sentence to determine the set of successfully matched commodity evaluation keywords.

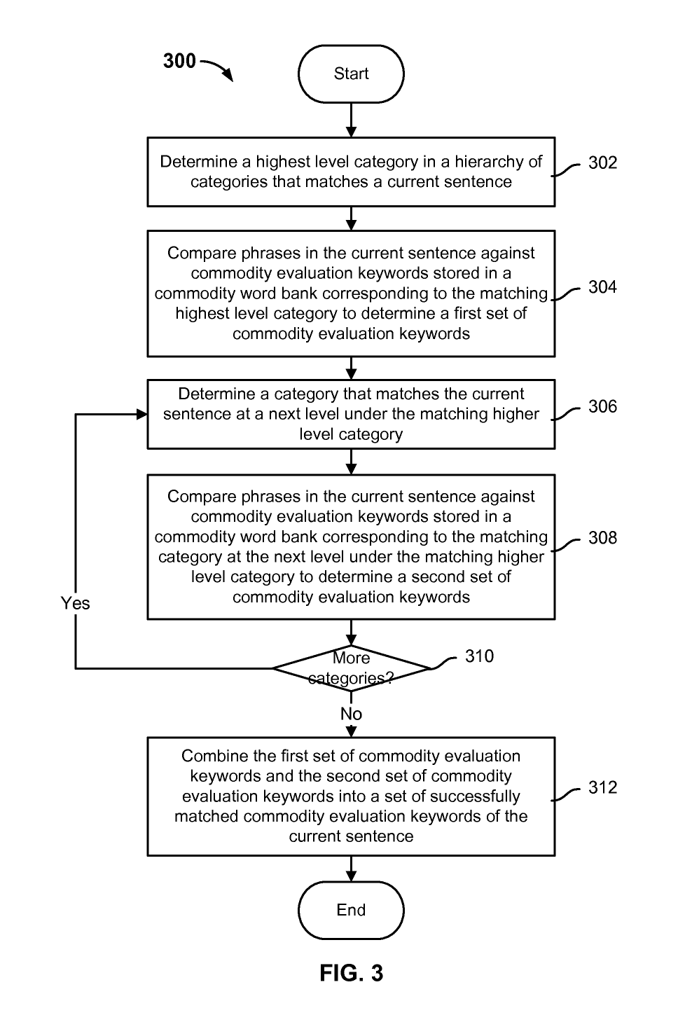

In some embodiments, each stored sentence of the commodity evaluation information is compared to a series of one or more commodity word banks, each corresponding to a different level of a hierarchy of commodity categories, starting from the highest level (e.g., level 1) category that is associated with the sentence, to determine successfully matched commodity evaluation keyword(s), if any, at each level. In some embodiments, the highest level category that can be determined to match a stored sentence is a main commodity category at level 1 of the hierarchy. For example, the sentence is determined to match a main commodity category at level 1 based on a phrase of the sentence matching metadata associated with the main commodity category, or based on some other technique. It should be noted that the highest level category in the hierarchy that is determined to match a stored sentence may be a level lower than level 1, in some instances, if a phrase in the sentence does not match the metadata (or other information) of any level 1 main category. Then, all the commodity evaluation keywords stored in a commodity word bank of the matching main commodity category is compared against the phrases of the sentence to determine whether a commodity evaluation keyword of the word bank matches any phrase included in the sentence. The matching commodity evaluation keywords of the commodity word bank of the matching main commodity category are stored in the set of successfully matched commodity evaluation keywords. Next, the sentence is first compared to a commodity word bank corresponding to a category at the next lower level under the matching main commodity, a commodity subcategory category at level 2 of the hierarchy. For example, a commodity subcategory under the matching main commodity category that matches the sentence is determined (e.g., based on a phrase of the sentence matching metadata associated with the commodity subcategory, or based on some other technique). Then, all the commodity evaluation keywords stored in a commodity word bank of the matching commodity subcategory are compared against the phrases of the sentence to determine whether a commodity evaluation keyword of the word bank matches any phrase included in the sentence. The matching commodity evaluation keywords of the commodity word bank of the matching commodity subcategory are stored in the set of successfully matched commodity evaluation keywords. The process may proceed in a similar manner for a subordinate category under the matching commodity subcategory at level 3, if any exists, and so forth. FIG. 3 below is an example of determining successfully matched commodity evaluation keywords for each sentence based on comparing the sentence to commodity word banks corresponding to commodity categories at various levels.

In some embodiments, a commodity evaluation keyword database is used instead of commodity word banks that correspond to categories at various levels of the hierarchy of commodity categories. The commodity evaluation keyword database may contain commodity evaluation keywords that correspond to all commodity categories. When a commodity evaluation keyword database is used, each phrase of a stored sentence from the obtained commodity evaluation information is compared against each of the commodity evaluation keywords stored in the database to determine successfully matched commodity evaluation keywords. For example, suppose that a commodity evaluation keyword database stores “citrusy,” “flavor,” “salty,” “carbonated beverage,” “beverage,” “mango,” “sweet and sour,” “tastes great,” and other such commodity evaluation keywords. For the example sentence of “The flavor of this type of beverage is very sweet,” the phrases of “beverage,” “flavor,” and “sweet” would be determined to be successfully matched commodity evaluation keywords. For the example sentence of “Today, we are introducing to everyone a carbonated beverage which was recently developed by Jianlibao Co.; it is called Mango-Plus; this style of beverage uses freshly-squeezed mango juice; the taste is sweet and sour, and it tastes great,” the phrases of “carbonated beverage,” “beverage,” “mango,” “sweet and sour,” and “tastes great” would be determined to be successfully matched commodity evaluation keywords.

The set of successfully matched commodity evaluation keywords includes successfully matched commodity evaluation keywords aggregated across all sentences extracted from the obtained commodity evaluation information.

In some embodiments, a stored sentence from the obtained commodity evaluation information is modified prior to being compared against one or more commodity word banks and/or a commodity evaluation keyword database. For example, modifying a sentence may remove one or more phrases from the sentence. Below are a few example techniques that may be used to modify a sentence prior to comparing it to one or more commodity word banks and/or a commodity evaluation keyword database:

Example technique 1: Match the sentence against non-commodity evaluation keywords in preset non-commodity keyword banks and remove from the sentence those phrases that matched the non-commodity evaluation keywords stored in the preset non-commodity keyword banks The purpose of this technique is to remove non-commodity evaluation keywords (e.g., “Ah,” “of,” “you,” “I,” “he,” and other modal particles, interjections, prepositions, pronouns, and so on) that are not related to commodities in the sentence. By reducing the number of non-commodity words in the sentence, fewer words of the sentence need to be compared against the commodity evaluation keywords of one or more commodity word banks and/or a commodity evaluation keyword database, which increases the efficiency of performing such comparisons.

Example technique 2: Remove duplicate phrases from the sentence. Any duplicate phrases within the sentence are removed. The purpose of this technique is also to reduce the number of phrases in the sentence and to increase the efficiency of the matching.

Either one or both of the example techniques of modifying a sentence may be used, in some embodiments.

The text analysis technique described with process 200 greatly differs from conventional techniques. Conventional text analysis techniques usually involve collecting a large quantity of review articles regarding commodities and then conducting analysis on each article. The conventional text analysis process comprises the following: the entire article is segmented word by word; all the adjectives are extracted from the segmented words; the weight of one adjective relative to the entire article is used for analysis, and the results of the analysis are matched against a word bank. The result is the scope and characteristic value of the adjective throughout the article. These steps are repeated until all of the adjectives have been matched, and the final step yields preference analysis results.

However, the conventional techniques have the following drawbacks:

I. The Conventional Techniques are Imprecise:

In certain languages sentences are often characterized by ambiguity and indeterminacy. In addition, the meanings of sentences are closely tied to the contexts in which they are used. Simply extracting adjectives does not necessarily enable an accurate analysis of tendencies. For example, the sentence: “How could such a person be a criminal?” is rhetorical and indicates emotions that are commendatory and laudatory. Yet the conventional techniques mentioned above will extract the adjective “criminal” and will likely conclude that the viewpoint of the author of the sentence is derogatory and hostile.

II. The Conventional Techniques are Inefficient:

The conventional techniques mentioned above compute the word frequencies and weights of all adjectives. In other words, conventional techniques count how many times an adjective appears in the entire article and computes its rank (e.g., high frequency, low frequency, medium frequency) relative to all other adjectives. This requires a large amount of statistical computing and also much repeated computing, which could be very inefficient.

Whereas the conventional techniques analyze ordinary commodity review articles, the embodiments described herein may analyze various types of commodity evaluation information to evaluate commodities. Since various types of commodity evaluation information that are analyzed may use objective and clear-cut phrases to accurately describe some attributes of commodities, such descriptions of the attributes (e.g., commodity evaluation keywords) may be extracted in analyzing the commodity reviews. Examples of attributes may include shape, quality, and size. Therefore, whereas conventional techniques extract adjectives for analysis, the embodiments described herein extract commodity evaluation keywords, which may be considered more objective and accurate.

At 212, the set of successfully matched commodity evaluation keywords is provided to a user interface.

In some embodiments, the determined set of successfully matched commodity evaluation keywords is sent to and provided to a user interface so that a user may view the determined commodity evaluation keywords determined in response to the commodity evaluation analysis request. In some embodiments, the user interface may be associated with the client device from which the commodity evaluation analysis request was sent. For example, the set of successfully matched commodity evaluation keywords may be displayed in a web browser as a webpage or via a software application.

In some embodiments, the successfully matched commodity evaluation keywords extracted in response to a particular commodity evaluation analysis request may be stored such that in the event that a commodity evaluation analysis request is received again, the previously stored successfully matched commodity evaluation keywords may be retrieved and provided to the user interface.

In some embodiments, each commodity evaluation keyword of the set of successfully matched commodity evaluation keywords is provided to a user interface with at least a portion of the original (e.g., unmodified) sentence in which it had appeared. In these embodiments, each commodity evaluation keyword of the set of successfully matched commodity evaluation keywords may be displayed at a user interface with at least a portion of the original (e.g., unmodified) sentence in which it had appeared to give the user more context about how the commodity evaluation keyword was originally used. The commodity evaluation keyword within the sentence may be specially formatted (e.g., bolded or highlighted) so as to appear more conspicuous. For example, if a successfully matched commodity evaluation keyword is “not bad,” it may be displayed in combination with part of the content (e.g., the subject) of the corresponding sentence “the mobile phone is not bad” in which it appeared. To give another example, if the commodity evaluation keyword is “normal,” it may be displayed in combination with part of the content (e.g., the subject) of the corresponding sentence “the packaging is normal” in which it appeared. In yet another example, if the commodity evaluation keyword is “typical,” it may be displayed in combination with part of the content (e.g., the subject) of the corresponding sentence “the accessories are typical” in which it appeared.

Other techniques of presenting the set of successfully matched commodity evaluation keywords at a user interface may be used as well.

FIG. 3 is a flow diagram showing an example process of determining a set of successfully matched commodity evaluation keywords. In some embodiments, process 300 is implemented at system 100 of FIG. 1.

Process 300 is an example process of comparing a stored sentence of the commodity evaluation information to a series of one or more commodity word banks, each corresponding to a different level of a hierarchy of commodity categories, starting from the highest level that is associated with the sentence. Process 300 may be repeated for each stored sentence of the obtained commodity evaluation information.

In summary, using process 300, it is possible to match a sentence to a commodity word bank corresponding to a category at each level of a hierarchy of categories starting from the category at the highest level that matches the sentence. The commodity evaluation keywords stored in a commodity word bank of one level are examined for possible matches before the commodity evaluation keywords stored in a commodity word bank at the next level down are matched, until a category at the next level down is not available. Due to the arrangement of storing commodity evaluation keywords common to multiple categories at a commodity word bank corresponding to a category at a higher level, each commodity word bank may include fewer commodity evaluation keywords and as a result, the efficiency of matching between a sentence and a matching commodity word bank at each of various levels of the hierarchy is improved.

At 302, a highest level category in a hierarchy of categories that matches a current sentence is determined. The current sentence is a stored sentence from the obtained commodity evaluation information that is currently being compared to commodity word banks.

At 304, phrases in the current sentence are compared against commodity evaluation keywords stored in a commodity word bank corresponding to the matching highest level category to determine a first set of commodity evaluation keywords.

At 306, a category that matches the current sentence at a next level under the matching higher level category is determined.

At 308, phrases in the current sentence are compared against the commodity evaluation keywords stored in a commodity word bank corresponding to the matching category at the next level under the matching higher level category and a second set of commodity evaluation keywords is determined.

At 310, it is determined whether the matching category at the next level under the matching higher level is the lowest-level category in the hierarchy. For example, if the matching category at the next level under the matching higher level does not have a category under it within the hierarchy, control is transferred to 312. Otherwise, control returns to 306.

At 312, the first set of commodity evaluation keywords and the second set of commodity evaluation keywords are combined into a set of successfully matched commodity evaluation keywords of the current sentence. The set of successfully matched commodity evaluation keywords of the current sentence represents the keyword extraction results from the current sentence matching process.

For example, assume the following represents four levels of commodity word banks corresponding to commodity categories at respective levels within a hierarchy of categories:

Food (level 1)->Beverages (level 2)->Carbonated Beverages (level 3)->Mouth Feel (level 4)

As shown above, a level 1 commodity word bank corresponds to the main commodity category of “Food.” A level 2 commodity word bank under the main commodity category of “Food” corresponds to the commodity subcategory of “Beverages.” A level 3 commodity word bank under the commodity subcategory of “Beverages” corresponds to the commodity subordinate category of “Carbonated Beverages.” A level 4 commodity word bank under the commodity subordinate category of “Carbonated Beverages” corresponds to the commodity subordinate category of “Mouth Feel.” In this example, assume that the commodity word bank corresponding to the level 4 subordinate category of “Mouth feel” includes at least the following three commodity evaluation keywords: “tastes great,” “tastes bad,” and “sweet and sour.” In some embodiments, the commodity evaluation keywords included in a commodity word bank corresponding to each commodity category are preset by a system administrator.

The following is an example of applying process 300 to a sentence using the above four levels of commodity word banks corresponding to commodity categories at respective levels within a hierarchy of categories:

Assume that the current sentence is: “Today, we are introducing to everyone a carbonated beverage which was recently developed by Jianlibao Co.; it is called Mango-Plus; this style of beverage uses freshly-squeezed mango juice; the taste is sweet and sour, and it tastes great.” At 302 of process 300, it is determined that the highest level category that matches the current sentence is the “Beverages” category at level 2. At 304 of process 300, each commodity evaluation keyword of the commodity word bank corresponding to “Beverages” is matched against the phrases of the sentence to determine a first set of commodity evaluation keywords. Assume that in this example, there are no matched commodity evaluation keywords corresponding to “Beverages” and so the first set of commodity evaluation keywords is empty. At 306 of process 300, it is determined that the category in the next level under the “Beverages” category is the “Carbonated Beverages” category at level 3. At 308 of process 300, each commodity evaluation keyword of the commodity word bank corresponding to “Carbonated Beverages” is matched against the phrases of the sentence to determine keywords to include in a second set of commodity evaluation keywords. Assume that in this example, there are no matched commodity evaluation keywords corresponding to “Carbonated Beverages.” At 310 of process 300, it is determined that there is another category at the level under “Carbonated Beverages,” level 4, which is “Mouth Feel.” Returning to 306 of process 300, each commodity evaluation keyword of the commodity word bank corresponding to “Mouth Feel” is matched against the phrases of the sentence to determine keywords to include in the second set of commodity evaluation keywords (308). In this example, the following are commodity evaluation keywords of the commodity word bank corresponding to the subordinate category of “Mouth Feel” that match the current sentence: “tastes great,” and “sweet and sour.” Thus, the second set of commodity evaluation keywords includes “tastes great,” and “sweet and sour.” At 312 of process 300, the first and second sets of commodity evaluation keywords are combined, which forms the set of successfully matched commodity evaluation keywords of the current sentence (e.g., the keyword extraction results from the current sentence matching process). In this example, because the first set of commodity evaluation keywords is empty, the set of successfully matched commodity evaluation keywords of the current sentence comprises only the commodity evaluation keywords of the second set of commodity evaluation keywords: “tastes great” and “sweet and sour.”

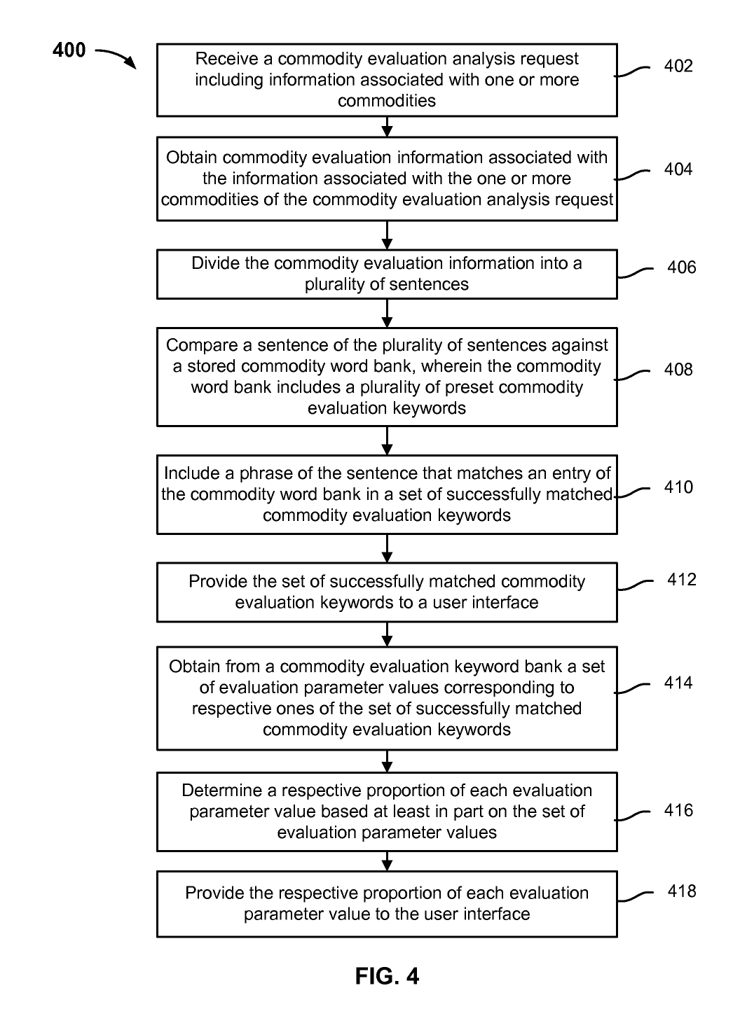

FIG. 4 is a flow diagram showing an embodiment of a process for analyzing commodity evaluations. In some embodiments, process 400 is implemented at system 100 of FIG. 1.

Process 400 is similar to process 200 of FIG. 2 but additionally provides evaluation parameter information corresponding to the set of successfully matched commodity evaluation keywords.

At 402, a commodity evaluation analysis request including information associated with one or more commodities is received. Step 402 may be performed in a manner similar to step 202 of process 200 of FIG. 2.

At 404, commodity evaluation information associated with the information associated with the one or more commodities of the commodity evaluation analysis request is obtained. Step 404 may be performed in a manner similar to step 204 of process 200 of FIG. 2.

At 406, the commodity evaluation information is divided into a plurality of sentences. Step 406 may be performed in a manner similar to step 206 of process 200 of FIG. 2.

At 408, a sentence of the plurality of sentences is compared against a stored commodity word bank, wherein the commodity word bank includes a plurality of preset commodity evaluation keywords. Step 408 may be performed in a manner similar to step 208 of process 200 of FIG. 2.

At 410, a phrase of the sentence that matches an entry of the commodity word bank is included in a set of successfully matched commodity evaluation keywords. Step 410 may be performed in a manner similar to step 210 of process 200 of FIG. 2.

At 412, the set of successfully matched commodity evaluation keywords are provided to a user interface. Step 412 may be performed in a manner similar to step 212 of process 200 of FIG. 2.

At 414, a set of evaluation parameter values corresponding to respective ones of the set of successfully matched commodity evaluation keywords is obtained from a commodity evaluation keyword bank.

In some embodiments, a commodity evaluation keyword bank is the same as a commodity word bank. As mentioned before, in some embodiments, each entry in a commodity word bank also includes a mapping between a commodity evaluation keyword and a corresponding evaluation parameter value. Put another way, each entry of a commodity word bank includes a mapping between a preset commodity evaluation keyword and a preset evaluation parameter value. In some embodiments, a commodity evaluation keyword bank is different and separate from the commodity word bank. In the embodiments where the commodity evaluation keyword bank is different and separate from the commodity word bank, entries of the commodity word bank include only preset commodity evaluation keywords and entries of the commodity evaluation keyword bank include mappings between preset commodity evaluation keywords and their respective preset corresponding evaluation parameter values.

The set of possible evaluation parameter values may be determined by a system administrator. The set of possible evaluation parameter values should range from various degrees of recommendation of a commodity by an author of the corresponding commodity evaluation keyword. One example set of evaluation parameter values include: “Commendatory,” “Neutral,” and “Derogatory” and another example set of evaluation parameter values include: “Positive,” “Neutral,” and “Negative.” For purposes of illustration, the three example possible evaluation parameter values that are used in examples below comprise: “Positive,” “Neutral,” and “Negative.” In various embodiments, one evaluation parameter value is mapped to each commodity evaluation keyword in an entry stored at a commodity word bank (or commodity word database). In some embodiments, which evaluation parameter value is to map to a particular commodity evaluation keyword may be determined by the designer of the commodity evaluation keyword bank.

Example entries from a commodity evaluation keyword bank are provided below in Tables 1, 2, and 3. Each example entry of the commodity evaluation keyword bank includes a mapping between a commodity evaluation keyword and a corresponding preset evaluation parameter value (e.g., “Positive,” “Neutral,” or “Negative”).

Table 1 below includes example mappings of various commodity evaluation keywords corresponding to the evaluation parameter value of “Positive.”

TABLE 1

| Evaluation | Commodity Evaluation |
|---|---|
| Parameter | Keyword |
| Positive | Comfortable |
| Positive | Pretty |
| Positive | Generous |
| Positive | Practical |
| Positive | Effective |
| Positive | Tastes good |

Table 2 below includes example mappings of various commodity evaluation keywords corresponding to the evaluation parameter value of “Neutral.”

TABLE 2

| Evaluation | Commodity Evaluation |
|---|---|
| Parameter | Keyword |
| Neutral | OK |
| Neutral | Neither good nor bad |

Table 3 below includes example mappings of various commodity evaluation keywords corresponding to the evaluation parameter value of “Negative.”

TABLE 3

| Evaluation | Commodity Evaluation |
|---|---|
| Parameter | Keyword |
| Negative | Tastes bad |
| Negative | Ugly |
| Negative | Smells bad |
| Negative | Doesn't last long |
| Negative | Poor material |

An evaluation parameter value corresponding to each commodity evaluation keyword of the set of successfully matched commodity evaluation keywords may be determined using mappings between commodity evaluation keywords and evaluation parameter values stored in the commodity evaluation keyword bank. For example, using Table 1 above, it can be determined that “Positive” is the preset evaluation parameter value corresponding to the commodity evaluation keyword of “Tastes good.” While the examples of Tables 1, 2, and 3 show only one preset evaluation parameter value corresponding to each commodity evaluation keyword, in practice, more than one preset evaluation parameter value may correspond to each commodity evaluation keyword.

In some embodiments, a phrase of a sentence of the obtained commodity evaluation information that is preceded by “not” (“not good”) is assigned the evaluation parameter value at the opposite end of the range of author approval/recommendation. For example, if the phrase of “delicious” were mapped to the highest degree of approval evaluation parameter value of “Positive,” then the phrase “not delicious” would be mapped to the lowest degree of approval evaluation parameter value of “Negative.”

At 416, a respective proportion of each evaluation parameter value is determined based at least in part on the set of evaluation parameter values.

Once the evaluation parameter value corresponding to each commodity evaluation keyword of the set of successfully determined commodity evaluation keywords has been determined, the set of commodity evaluation keywords may be sorted by value. For example, assuming that there are the three possible evaluation parameter values of “Positive,” “Neutral,” and “Negative,” the set of evaluation parameter values may be sorted into three groups: one group associated with the evaluation parameter value of “Positive,” one group associated with the evaluation parameter value of “Neutral,” and one group associated with the evaluation parameter value of “Negative.” To determine the proportion of each evaluation parameter value, the total count of all evaluation parameter values corresponding to respective ones of the set of successfully matched commodity evaluation keywords is determined and a count of each evaluation parameter value is determined. The proportion of each evaluation parameter value may be determined as the ratio (or percentage) of the count of that evaluation parameter value to the total count of all determined evaluation parameter values.

At 418, the respective proportion of each evaluation parameter value is provided to the user interface.

The determined proportion of each evaluation parameter value of the set of evaluation parameter values corresponding to the set of successfully matched commodity evaluation keywords may be sent to a client (e.g., associated with sending the commodity evaluation analysis request). The determined proportion of each evaluation parameter value may be displayed at a user interface. For example, the determined proportion of each evaluation parameter value may be displayed at a webpage or via a software application.

For example, assume there are 50 evaluation parameter values determined for 50 corresponding successfully matched commodity evaluation keywords determined for a commodity evaluation analysis request for commodity A. 35 of the 50 evaluation parameter values are “Positive,” ten of the 50 evaluation parameter values are “Neutral,” and five evaluation parameter values are “Negative.” Thus, the proportion of each evaluation parameter value is as follows: “Positive”: (35/50=) 70%, “Neutral”: (10/50=) 20%, and “Negative”: (5/50=) 10%. Thus, evaluation parameter value proportions of “Positive”: 70%, “Neutral”: 20%, and “Negative”: 10% may be presented at a user interface. Such proportions of evaluation parameter values may inform the user of the relative amounts of each evaluation parameter value (e.g., “Positive,” “Neutral,” and “Negative”) that was used in the analyzed commodity evaluations for the identified commodity.

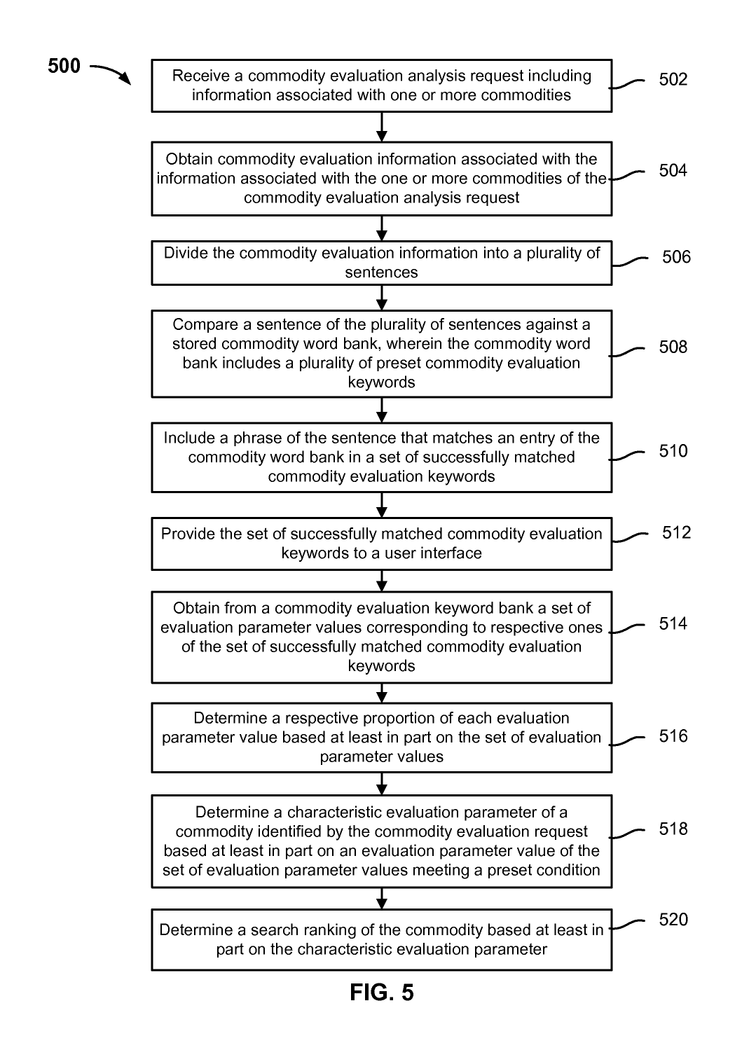

FIG. 5 is a flow diagram showing an embodiment of a process for analyzing commodity evaluations. In some embodiments, process 500 is implemented at system 100 of FIG. 1.

Process 500 is similar to process 400 of FIG. 4 but additionally determines a characteristic evaluation parameter of a commodity.

At 502, a commodity evaluation analysis request including information associated with one or more commodities is received. Step 502 may be performed in a manner similar to step 202 of process 200 of FIG. 2.

At 504, commodity evaluation information associated with the information associated with the one or more commodities of the commodity evaluation analysis request is obtained. Step 504 may be performed in a manner similar to step 204 of process 200 of FIG. 2.

At 506, the commodity evaluation information is divided into a plurality of sentences. Step 506 may be performed in a manner similar to step 206 of process 200 of FIG. 2.

At 508, a sentence of the plurality of sentences is compared against a stored commodity word bank, wherein the commodity word bank includes a plurality of preset commodity evaluation keywords. Step 508 may be performed in a manner similar to step 208 of process 200 of FIG. 2.

At 510, a phrase of the sentence that matches an entry of the commodity word bank is included in a set of successfully matched commodity evaluation keywords. Step 510 may be performed in a manner similar to step 210 of process 200 of FIG. 2.

At 512, the set of successfully matched commodity evaluation keywords is provided to a user interface. Step 512 may be performed in a manner similar to step 212 of process 200 of FIG. 2.

At 514, a set of evaluation parameter values corresponding to respective ones of the set of successfully matched commodity evaluation keywords is obtained from a commodity evaluation keyword bank. Step 514 may be performed in a manner similar to step 414 of process 400 of FIG. 4.

At 516, a respective proportion of each evaluation parameter value is determined based at least in part on the set of evaluation parameter values. Step 516 may be performed in a manner similar to step 416 of process 400 of FIG. 4.

At 518, a characteristic evaluation parameter is determined for a commodity identified by the commodity evaluation analysis request based at least in part on an evaluation parameter value of the set of evaluation parameter values meeting a preset condition.

A new parameter, referred to herein as the “characteristic evaluation parameter” is determined for the commodity (or commodities) identified in the commodity evaluation analysis request based on the set of evaluation parameter values. The characteristic evaluation parameter is determined to be one or more evaluation parameter values depending on which one or more evaluation parameter values match a preset condition. In some embodiments, the determined characteristic evaluation parameter for a commodity includes the evaluation parameter value that meets the condition and also the proportion of that evaluation parameter value (e.g., determined at step 516).

In some embodiments, an evaluation parameter value is determined to be a characteristic evaluation parameter if the proportion associated with the evaluation parameter value meets the condition of exceeding or being below a certain threshold value. In other words, when the proportion of an evaluation parameter value exceeds a certain threshold value associated with that evaluation parameter value, the evaluation parameter value is determined to be a characteristic evaluation parameter. The threshold value may be preset by a system administrator. For example, the threshold for the “Positive” evaluation parameter value may be set to ≧40%. In another example, the thresholds and threshold ranges of proportions corresponding to “Positive,” “Negative,” and “Neutral” evaluation parameter values are respectively >60%, ≧50% and ≦60%, and <50%, respectively.

In some embodiments, an evaluation parameter value is determined to be a characteristic evaluation parameter if the proportion associated with the evaluation parameter value meets the condition of being relatively greater than the proportions of the other evaluation parameter values. For example, let us assume that there are three possible evaluation parameter values: “Positive,” “Neutral,” and “Negative.” In this example, the proportion of each evaluation parameter is as follows:

Positive: 49.72%, Negative: 25.63%, Neutral: 24.65%.

Because the 49.72% proportion for the “Positive” evaluation parameter value exceeds a certain threshold value preset for the “Positive” evaluation parameter value of 40% and is higher than the proportions of the other two threshold values, the “Positive” evaluation parameter value and its respective 49.72% proportion can be determined as a characteristic evaluation parameter. The determined characteristic evaluation parameter(s) for the commodity may be stored.

At 520, a search ranking of the commodity is determined based on the characteristic evaluation parameter.

The characteristic evaluation parameter stored for the commodity may be retrieved in response to a subsequently received commodity search request. When a commodity search request sent by a user is obtained, matching commodity search results can be obtained using the search keywords of the commodity search request or other information. Prior to sending the commodity search results back to the user, the searching rank of a commodity in the matched commodity search results may be adjusted with reference to that commodity's characteristic evaluation parameter and the proportion of the characteristic evaluation parameter. For example, assume that within commodity search results, commodity A has the stored characteristic evaluation parameter of a “Positive” evaluation parameter value with a proportion of 49.72%, and commodity B has the stored characteristic evaluation parameter of a “Positive” evaluation parameter value with a proportion of 35.72%. In this example, among the commodity search results that are sent back, the commodity A search result is ranked ahead of the commodity B search result. Or, in another example, if, among the commodity search results, the characteristic evaluation parameter corresponding to commodity C has a characteristic evaluation parameter value of “Negative” with a proportion of 65.82%, the search ranking for commodity C may be lowered. The search ranking of the commodity may be adjusted in other ways by the characteristic evaluation parameters determined for the commodities of the found search results.

In some embodiments, commodities may be stored with their respective characteristic evaluation parameters. If the characteristic evaluation parameter for a commodity is the evaluation parameter value of “Positive,” then a “Positive” mark will be added to the commodity in a commodity database. For example, a user may perform a search for commodities with search conditions or options based on the characteristic evaluation parameter. When the user chooses to use the characteristic evaluation parameter to conduct a commodity search, he or she may limit the search to return only commodity search results having a particular characteristic evaluation parameter mark. For example, if the user wishes to search commodities having a “Positive” mark, the system may automatically search commodities marked with the characteristic evaluation parameter of “Positive.”

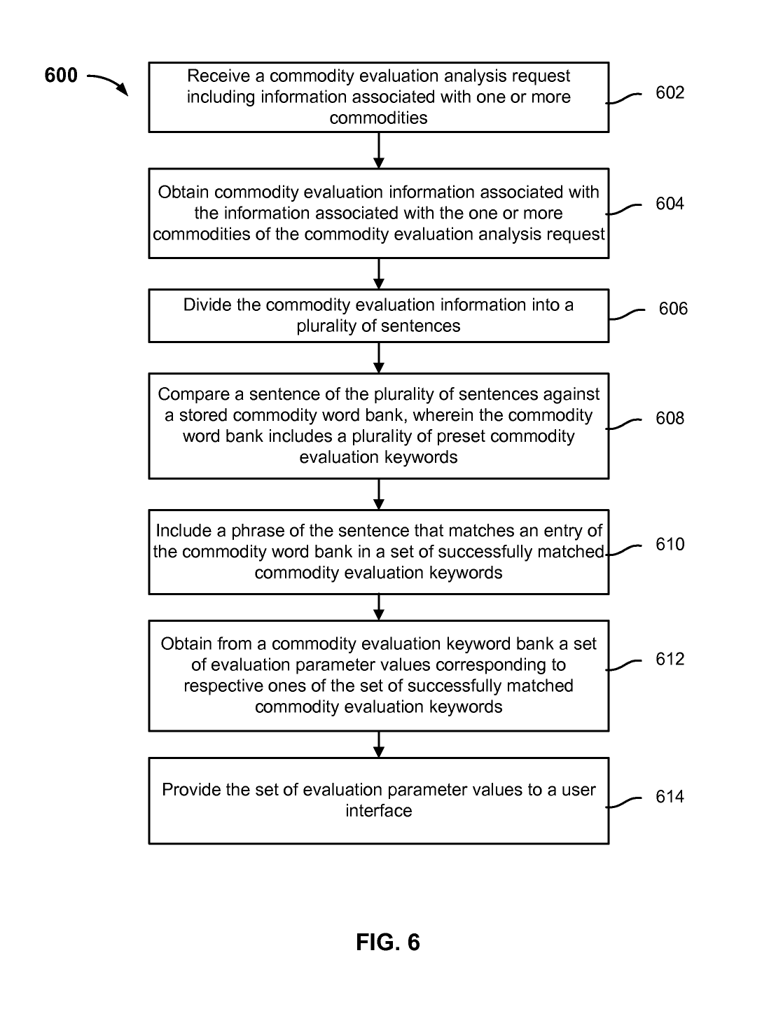

FIG. 6 is a flow diagram showing an embodiment of a process for analyzing commodity evaluations. In some embodiments, process 600 is implemented at system 100 of FIG. 1.

Process 600 is similar to process 200 of FIG. 2 and process 400 of FIG. 4 but does not provide the determined set of commodity evaluation keywords to a user interface or necessarily provide the determined respective proportion of each type of evaluation parameter value at the user interface.

At 602, a commodity evaluation analysis request including information associated with one or more commodities is received. Step 602 may be performed in a manner similar to step 202 of process 200 of FIG. 2.

At 604, commodity evaluation information associated with the information associated with the one or more commodities of the commodity evaluation analysis request is obtained. Step 604 may be performed in a manner similar to step 204 of process 200 of FIG. 2.

At 606, the commodity evaluation information is divided into a plurality of sentences. Step 606 may be performed in a manner similar to step 206 of process 200 of FIG. 2.

At 608, a sentence of the plurality of sentences is compared against a stored commodity word bank, wherein the commodity word bank includes a plurality of preset commodity evaluation keywords. Step 608 may be performed in a manner similar to step 208 of process 200 of FIG. 2.

At 610, a phrase of the sentence that matches an entry of the commodity word bank is included in a set of successfully matched commodity evaluation keywords. Step 610 may be performed in a manner similar to step 210 of process 200 of FIG. 2.

At 612, a set of evaluation parameter values corresponding to respective ones of the set of successfully matched commodity evaluation keywords are obtained from a commodity evaluation keyword bank. Step 612 may be performed in a manner similar to step 414 of process 400 of FIG. 4.

At 614, the set of evaluation parameter values are provided to a user interface.

In some embodiments, each evaluation parameter value (e.g., “Positive,” “Negative,” or “Neutral”) is displayed at a user interface. For example, the set of evaluation parameter values is sent to the client device from which the commodity evaluation analysis request was sent and each evaluation parameter value of the set is displayed at the user interface of the client device.

In some embodiments, a respective proportion of each type of evaluation parameter value is determined based at least in part on the set of evaluation parameter values (e.g., in a manner similar to step 416 of process 400 of FIG. 4). In some embodiments, the respective proportion of each type of evaluation parameter value is provided to the user interface (e.g., in a manner similar to step 418 of process 400 of FIG. 4).

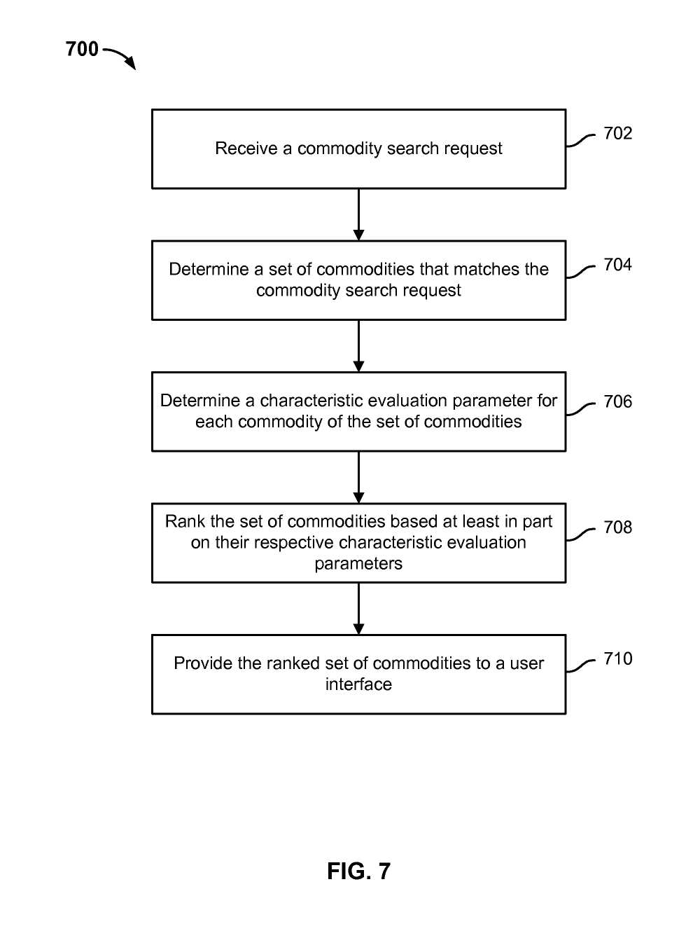

FIG. 7 is a flow diagram showing an embodiment of a process for performing a search for a commodity. In some embodiments, process 700 is implemented at system 100 of FIG. 1.

At 702, a commodity search request is received.

A commodity search request may be received from a client device. For example, a user of the client device may desire to search for commodities at a website and/or search engine and submit a search request accordingly. For example, a commodity search request may include keywords and/or other search conditions. For example, a user may input the keywords “winter clothing new styles” in a search engine of an e-commerce website and then click the preset control of “Search” to begin the search. These actions will then generate a commodity search request that is submitted to the server.

At 704, a set of commodities that matches the commodity search request is determined. One or more commodities that match information (e.g., search keywords or other search conditions) of the commodity search request are determined.

At 706, a characteristic evaluation parameter is determined for each commodity of the set of commodities. In various embodiments, to determine a characteristic evaluation parameter for a commodity in the matching set of commodities, a commodity evaluation analysis request is generated on behalf of that commodity. In various embodiments, the commodity evaluation analysis request generated for each commodity is processed by a process such as steps 502-518 of process 500 of FIG. 5. The characteristic evaluation parameter for a commodity may include an evaluation parameter value and a corresponding determined proportion.

At 708, the set of commodities is ranked based at least in part on their respective characteristic evaluation parameters.

The matching commodities of the set may be ranked based at least in part on their respective characteristic evaluation parameters and corresponding proportions. There may be various different techniques by which the matching commodities may be ranked by their respective characteristic evaluation parameters and corresponding proportions. One example technique by which to rank the commodities is to rank those with characteristic evaluation parameters of highest degree of recommendation (e.g., “Positive”) highest and to rank those commodities with the highest degree of recommendation in an order based on their respective proportions (e.g., the higher the proportion of the “Positive” evaluation parameter value, the higher the corresponding commodity is ranked among the commodities of the search results). Another example technique by which to rank the commodities is to rank those with characteristic evaluation parameters of lowest degree of recommendation (e.g., “Negative”) lowest and in an order based on their respective proportions (e.g., the lower the proportion of the “Negative” evaluation parameter value, the higher the corresponding commodity is ranked among the commodities of the search results).

At 710, the ranked set of commodities is provided to a user interface.

For example, the ranked search results may be presented at the user interface of the client device from which the commodity search request was sent.

For example, assume that commodity A and commodity B were determined to match the commodity search request. After generating a commodity evaluation analysis request for each of commodity A and commodity B, the determined characteristic evaluation parameter for commodity A is “Positive” evaluation parameter value with the proportion of 49.72% and the determined characteristic evaluation parameter for commodity B is “Positive” evaluation parameter value with the proportion of 35.72%. In one example ranking technique, because commodity A's “Positive” evaluation parameter value has the higher proportion of 49.72% and commodity B's “Positive” evaluation parameter value has the lower proportion of 35.72%, commodity A would be ranked higher than commodity B among the search results provided to the user interface.

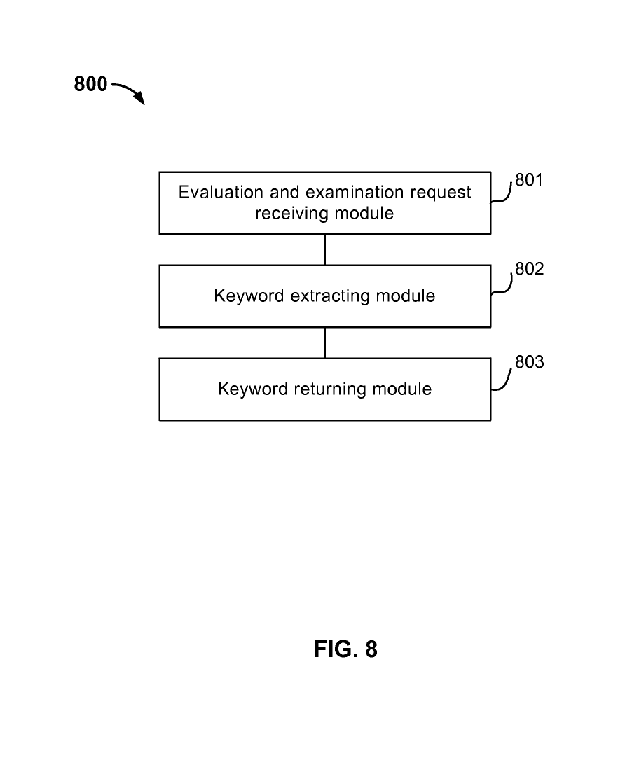

FIG. 8 is a diagram showing an embodiment of a system for analyzing commodity evaluations. In the example, system 800 includes evaluation and examination request receiving module 801, keyword extracting module 802, and keyword returning module 803.

The modules and sub-modules can be implemented as software components executing on one or more processors, as hardware such as programmable logic devices and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and sub-modules may be implemented on a single device or distributed across multiple devices.

Evaluation and examination request receiving module 801 is configured to receive commodity evaluation analysis requests.

Keyword extracting module 802 is configured to obtain commodity evaluation information associated with the information associated with the one or more commodities of the commodity evaluation analysis request. In some embodiments, the commodity evaluation information used to evaluate the commodities may be collected from designated databases or obtained using a web crawler. Keyword extracting module 802 is also configured to divide the commodity evaluation information into a plurality of sentences. Keyword extracting module 802 is also configured to compare a sentence of the plurality of sentences against a stored commodity word bank, wherein the commodity word bank includes a plurality of preset commodity evaluation keywords and includes a phrase of the sentence that matches an entry of the commodity word bank in a set of successfully matched commodity evaluation keywords.

Keyword returning module 803 is configured to provide the set of successfully matched commodity evaluation keywords at a user interface.

In some embodiments, commodity word banks are arranged in a hierarchical manner. In such embodiments, system 800 further includes:

A first word bank establishing sub-module that is configured to establish a commodity measure word bank corresponding to each preset main commodity category at level 1 of the hierarchy.

A second word bank establishing sub-module that is configured to establish a commodity measure word bank corresponding to each preset sub-category at level 2 of the hierarchy.

A third word bank establishing sub-module that is configured to establish a commodity measure word bank for each subordinate category at each level 3 or more (e.g., level 4, level 5, etc.) of the hierarchy.

In some embodiments, keyword extracting module 802 includes the following:

A first extraction sub-module that is configured to match each sentence against non-commodity evaluation keywords stored in non-commodity keyword banks and remove from each sentence those phrases that matched non-commodity evaluation keywords.

A second extraction sub-module that is configured to remove duplicate phrases from each sentence.

In some embodiments, system 800 further includes:

A content returning module that is configured to provide to the user interface at least a portion of the sentence from which each commodity evaluation keyword from the set of successfully matched commodity evaluation keywords appears in the obtained commodity evaluation information.

In some embodiments, system 800 further includes:

An evaluation parameter acquiring module that is configured to obtain the evaluation parameter values corresponding to respective ones of the set of successfully matched commodity evaluation keywords.

A proportion computing module that is configured to determine to a proportion that each evaluation parameter value appears within all the evaluation parameter values of the determined set of evaluation parameter values.

A proportion returning module that is configured to provide each evaluation parameter value and its proportion at the user interface.

In some embodiments, the evaluation parameter acquiring module may further comprise the sub-modules below:

A pre-establishing sub-module that is configured to establish one or more commodity evaluation keyword banks

A keyword acquiring sub-module that is configured to obtain a set of evaluation parameter values corresponding to respective ones of the set of successfully matched commodity evaluation parameters from the one or more commodity evaluation keyword banks.

In some embodiments, system 800 further includes:

A characteristic evaluation parameter extracting module that is configured to determine a characteristic evaluation parameter for a commodity identified in a commodity evaluation analysis request as an evaluation parameter value (and its corresponding proportion) that meets a preset condition.

An adjusting module that is configured to use the characteristic evaluation parameter and the corresponding proportion to adjust the search ranking of the corresponding commodity.

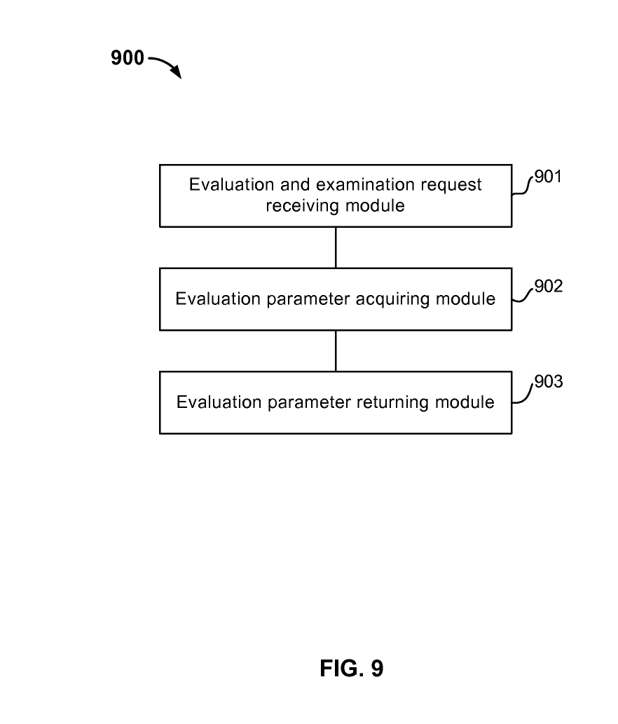

FIG. 9 is a diagram showing an embodiment of a system for analyzing commodity evaluations. In the example, system 900 includes evaluation and examination request receiving module 901, evaluation parameter acquiring module 902, and evaluation parameter returning module 903.

Evaluation and examination request receiving module 901 is configured to receive commodity evaluation analysis requests.

Evaluation parameter acquiring module 902 is configured to obtain a set of evaluation parameter values corresponding to respective ones of the set of successfully matched commodity evaluation keywords determined for a commodity evaluation analysis request. For example, the set of successfully matched commodity evaluation keywords may be determined by keyword extracting module 802 of system 800 of FIG. 8.

Evaluation parameter returning module 903 is configured to provide the set of evaluation parameter values.

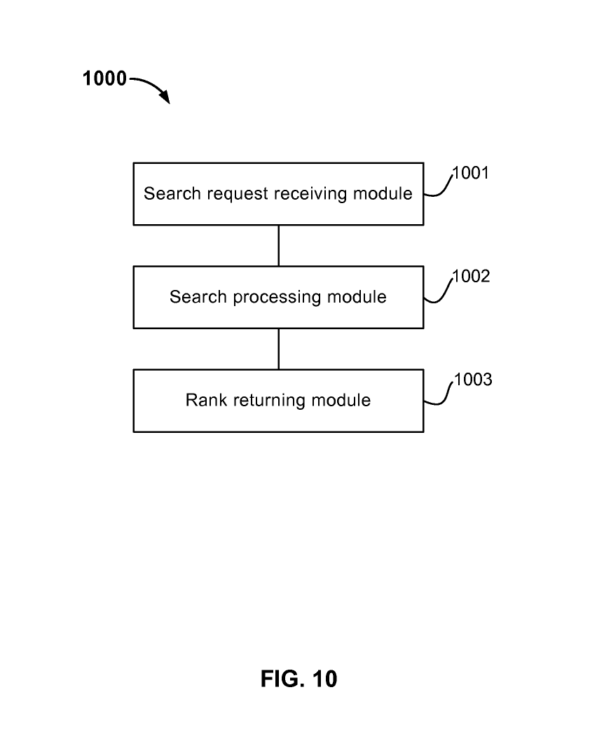

FIG. 10 is a diagram showing an embodiment of a system for performing a search of commodities. In the example, system 1000 includes search request receiving module 1001, search processing module 1002, and rank returning module 1003.

Search request receiving module 1001 is configured to receive commodity search requests.

Search processing module 1002 is configured to find a set of commodities that matches a commodity search request. Search processing module 1002 is also configured to generate a commodity evaluation analysis request for each commodity of the matching set of commodities. The commodity evaluation analysis request for each commodity may be processed to determine the characteristic evaluation parameter (and its corresponding proportion). For example, the characteristic evaluation parameter may be determined for each commodity by the characteristic evaluation parameter extracting module of system 800 of FIG. 8.

Rank returning module 1003 is configured to rank the set of commodities based at least in part on their corresponding characteristic evaluation parameters (and corresponding proportions). Rank returning module 1003 is also configured to provide the ranked commodities to the user interface.

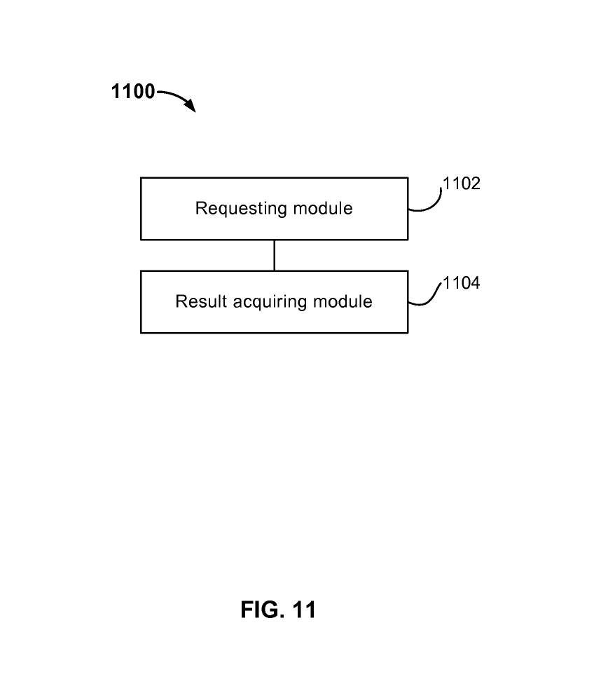

FIG. 11 is a diagram showing an embodiment of a system for receiving commodity evaluation analysis results. In the example, system 1100 includes requesting module 1102 and result acquiring module 1104.

Requesting module 1102 is configured to send commodity evaluation analysis requests and/or commodity search requests to servers. For example, a commodity evaluation analysis result may be sent to system 800 of FIG. 8 or system 900 of FIG. 9. For example, a commodity search request may be sent to system 1000 of FIG. 10.

Result acquiring module 1104 is configured to receive the processing results sent back by servers in response to the requests. For example, processing results in response to a commodity evaluation analysis request may include a set of successfully matched commodity evaluation keywords and/or information associated with a set of evaluation parameters. For example, processing results in response to a commodity search request may include ranked commodities.

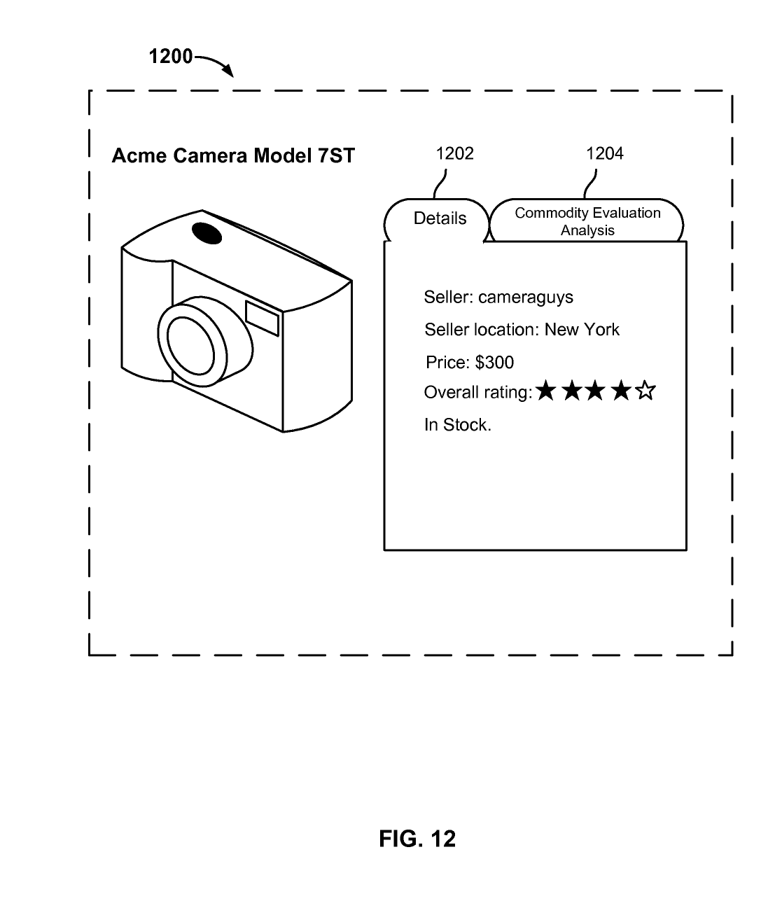

FIG. 12 is a diagram showing an example of a user interface displaying information associated with a commodity. In the example, user interface 1200 represents a web page at an e-commerce website associated with presenting information about a commodity. In the example, the commodity is titled “Acme Camera Model 7ST.” In the example, details tab 1202 has been selected so commodity information (e.g., seller identification, seller location, price, overall rating, and whether the commodity is currently in stock) is presented to the user. In this example, in the event that the user wished to view the set of successfully matched commodity evaluation keywords for the commodity titled “Acme Camera Model 7ST,” then the user can select commodity evaluation analysis tab 1204. By virtue of selecting commodity evaluation analysis tab 1204, a commodity evaluation analysis request may be issued for the “Acme Camera Model 7ST” commodity. For example, the commodity evaluation analysis request may be processed by a process such as process 200 of FIG. 2, process 400 of FIG. 4, process 500 of FIG. 5, and process 600 of FIG. 6.

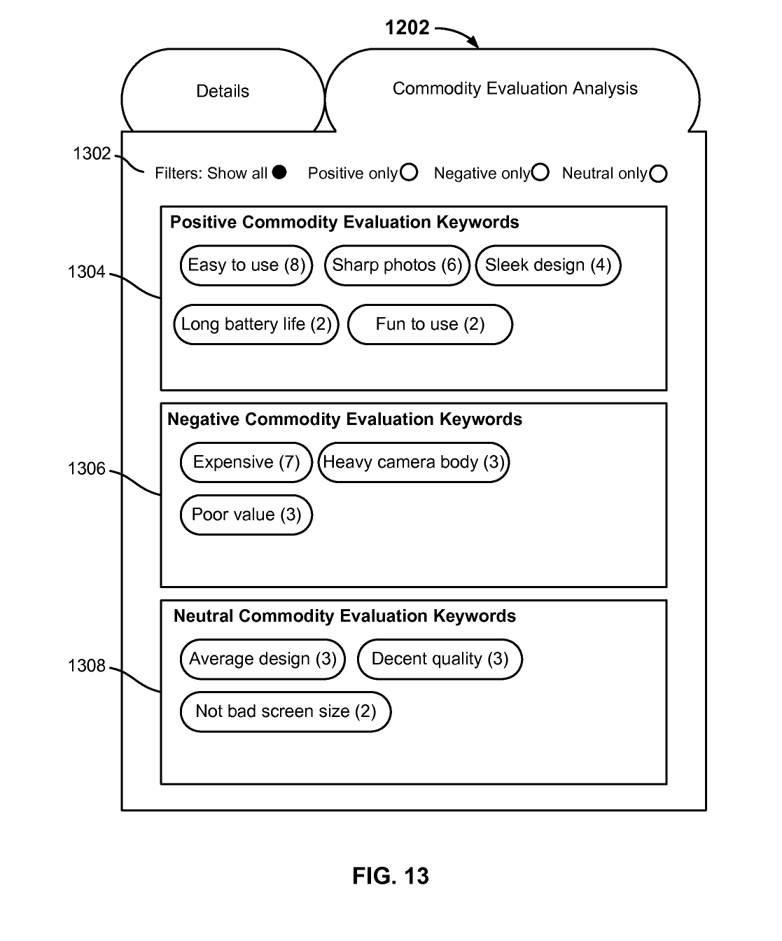

FIG. 13 is a diagram showing an example of a user interface displaying a set of successfully matched commodity evaluation keywords and their respective evaluation parameter values. FIG. 13 is an example of the display that is presented in response to a user selection of commodity evaluation analysis tab 1204 of user interface 1200 of FIG. 12. FIG. 13 shows one example presentation of various successfully matched commodity evaluation keywords and their corresponding evaluation parameter values. For example, the successfully matched commodity evaluation keywords can be determined from obtained commodity evaluation information related to the “Acme Camera Model 7ST” using a process such as process 200 of FIG. 2 and their respective evaluation parameter values can be determined by a process such as process 400 of FIG. 4. In the example, there are three possible evaluation parameters values: “Positive,” “Negative,” and “Neutral.”

The example of FIG. 13 also shows that the commodity evaluation keywords are grouped by their corresponding evaluation parameter values (e.g., “Positive,” “Negative,” or “Neutral”). The commodity evaluation keywords associated with the “Positive” evaluation parameter value are grouped together and displayed at area 1304, the commodity evaluation keywords associated with the “Negative” evaluation parameter value are grouped together and displayed at area 1306, and the commodity evaluation keywords associated with the “Neutral” evaluation parameter value are grouped together and displayed at area 1308. In the example, each commodity evaluation keyword is associated with a number within parentheses (e.g., “Easy to use (8)”) that represents the number of instances that the commodity evaluation keyword was found among the obtained commodity evaluation information. A user may apply a filter to the presented commodity evaluation keywords to only show commodity evaluation keywords associated with a certain evaluation parameter value by making a selection at area 1302. Currently, the option of “Show all” has been selected (so commodity evaluation keywords associated with any evaluation parameter value are presented) but the user may filter out commodity evaluation keywords associated with evaluation parameter values of “Negative” and “Neutral” by selecting the “Positive only” option, filter out commodity evaluation keywords associated with evaluation parameter values of “Positive” and “Neutral” by selecting the “Negative only” option, or filter out commodity evaluation keywords associated with evaluation parameter values of “Positive” and “Negative” by selecting the “Neutral only” option. By viewing the successfully matched commodity evaluation keywords and their respective evaluation parameter values, a user may quickly get a sense of the positive evaluation descriptions of the commodity, the negative evaluation descriptions of the commodity, and/or the neutral evaluation descriptions of the commodity without manually reviewing any commodity evaluation information.

A person skilled in the art should understand that the embodiment of the present application can be provided as methods, systems or computer software products. Therefore, the present application can take the form of embodiments consisting entirely of hardware, embodiments consisting entirely of software, and embodiments which combine software and hardware. In addition, the present application can take the form of computer program products implemented on one or more computer-operable storage media (including but not limited to magnetic disk storage devices, CD-ROM, and optical storage devices) containing computer operable program codes.

The present application is described with reference to flow charts and/or block diagrams based on methods, equipment (systems) and computer program products. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data processing equipment so as to give rise to a machine, with the result that the commands executed through the computer or processor of other programmable data processing equipment give rise to a device that is used to realize the functions designated by one or more processes in a flow chart and/or one or more blocks in a block diagram.

These computer program commands can also be stored on specially-operating computer-readable storage devices that can guide computers or other programmable data processing equipment, with the result that the commands stored on these computer-readable devices give rise to commodities that include command devices. These command devices realize the functions designated in one or more processes in a flow chart and/or one or more blocks in a block diagram.

These computer program commands can also be loaded onto a computer or other programmable data processing equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although preferred embodiments of the present application have already been described, a person skilled in the art can make other modifications or revisions to these embodiments once he grasps the basic creative concept.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive a commodity evaluation analysis request including information associated with a commodity;
obtain commodity evaluation information associated with the information associated with the commodity of the commodity evaluation analysis request;
divide the commodity evaluation information into a plurality of sentences;
compare a sentence of the plurality of sentences against a stored commodity word bank, wherein the commodity word bank includes a plurality of preset commodity evaluation keywords;
include a phrase of the sentence that matches an entry of the commodity word bank in a set of successfully matched commodity evaluation keywords; and
provide the set of successfully matched commodity evaluation keywords to a user interface; and
one or more memories coupled to the one or more processors and configured to provide the one or more processors with instructions.

2. The system of claim 1, wherein the commodity evaluation information includes one or more of the following: a document that evaluates the commodity, a document that describes the commodity, and a document that describes a trial use of the commodity.

3. The system of claim 1, wherein the commodity word bank is included in a plurality of commodity word banks, wherein a first commodity word bank of the plurality of commodity word banks corresponds to a commodity category at a first level of a hierarchy of commodity categories and a second commodity word bank of the plurality of commodity word banks corresponds to a commodity category at a second level of the hierarchy of commodity categories.

4. The system of claim 3, wherein to compare the sentence of the plurality of sentences against the plurality of commodity word banks includes to:
determine a highest level category in the hierarchy of categories that matches the sentence;
compare phrases in the sentence against commodity evaluation keywords stored in a commodity word bank corresponding to the matching highest level category;
determine a category that matches the sentence at a next level under the matching highest level category; and
compare phrases in the sentence against commodity evaluation keywords stored in a commodity word bank corresponding to the matching category at the next level under the matching highest level category.

5. The system of claim 1, wherein the one or more processors are further configured to obtain from a commodity evaluation keyword bank a set of evaluation parameter values corresponding to respective ones of the set of successfully matched commodity evaluation keywords, wherein the commodity evaluation keyword bank includes mappings between commodity evaluation keywords and corresponding evaluation parameter values.

6. The system of claim 5, wherein the one or more processors are further configured to provide the set of evaluation parameter values to the user interface.

7. The system of claim 5, wherein the set of successfully matched commodity evaluation keywords are grouped by respective evaluation parameter values in a presentation at the user interface.

8. The system of claim 5, wherein the one or more processors are further configured to determine a respective proportion of each evaluation parameter value based at least in part on the set of evaluation parameter values.

9. The system of claim 8, wherein the one or more processors are further configured to provide the respective proportion of each evaluation parameter value to the user interface.

10. The system of claim 8, wherein the one or more processors are further configured to determine a characteristic evaluation parameter of the commodity based at least in part on an identified evaluation parameter value of the set of evaluation parameter values meeting a preset condition, wherein the characteristic evaluation parameter comprises the identified evaluation parameter value and a respective proportion of the identified evaluation parameter value.

11. The system of claim 10, wherein the one or more processors are further configured to:
receive a commodity search request;
determine a set of commodities that matches the commodity search request, wherein the set of commodities includes the commodity; and
rank the commodity among the set of commodities based at least in part on the characteristic evaluation parameter of the commodity.

12. A method, comprising:
receiving a commodity evaluation analysis request including information associated with a commodity;
obtaining, using one or more processors, commodity evaluation information associated with the information associated with the commodity of the commodity evaluation analysis request;
dividing the commodity evaluation information into a plurality of sentences;
comparing a sentence of the plurality of sentences against a stored commodity word bank, wherein the commodity word bank includes a plurality of preset commodity evaluation keywords;
including a phrase of the sentence that matches an entry of the commodity word bank in a set of successfully matched commodity evaluation keywords; and
providing the set of successfully matched commodity evaluation keywords to a user interface.

13. The method of claim 12, wherein the commodity evaluation information includes one or more of the following: a document that evaluates the commodity, a document that describes the commodity, and a document that describes a trial use of the commodity.

14. The method of claim 12, wherein the commodity word bank is included in a plurality of commodity word banks, wherein a first commodity word bank of the plurality of commodity word banks corresponds to a commodity category at a first level of a hierarchy of commodity categories and a second commodity word bank of the plurality of commodity word banks corresponds to a commodity category at a second level of the hierarchy of commodity categories.

15. The method of claim 14, wherein comparing the sentence of the plurality of sentences against the plurality of commodity word banks includes:
determining a highest level category in the hierarchy of categories that matches the sentence;
comparing phrases in the sentence against commodity evaluation keywords stored in a commodity word bank corresponding to the matching highest level category;
determining a category that matches the sentence at a next level under the matching highest level category; and
comparing phrases in the sentence against commodity evaluation keywords stored in a commodity word bank corresponding to the matching category at the next level under the matching highest level category.

16. The method of claim 12, further comprising obtaining from a commodity evaluation keyword bank a set of evaluation parameter values corresponding to respective ones of the set of to successfully matched commodity evaluation keywords, wherein the commodity evaluation keyword bank includes mappings between commodity evaluation keywords and corresponding evaluation parameter values.

17. The method of claim 16, further comprising providing the set of evaluation parameter values to the user interface.

18. The method of claim 16, further comprising determining a respective proportion of each evaluation parameter value based at least in part on the set of evaluation parameter values.

19. The method of claim 18, further comprising providing the respective proportion of each evaluation parameter value to the user interface.

20. The method of claim 18, further comprising determining a characteristic evaluation parameter of the commodity based at least in part on an identified evaluation parameter value of the set of evaluation parameter values meeting a preset condition, wherein the characteristic evaluation parameter comprises the identified evaluation parameter value and a respective proportion of the identified evaluation parameter value.

21. The method of claim 20, further comprising:
receiving a commodity search request;
determining a set of commodities that matches the commodity search request, wherein the set of commodities includes the commodity; and
ranking the commodity among the set of commodities based at least in part on the characteristic evaluation parameter of the commodity.

22. A computer program product, the computer program product being embodied in a non-transitory computer readable storage medium and comprising computer instructions for:
receiving a commodity evaluation analysis request including information associated with a commodity;
obtaining commodity evaluation information associated with the information associated with the commodity of the commodity evaluation analysis request;
dividing the commodity evaluation information into a plurality of sentences;
comparing a sentence of the plurality of sentences against a stored commodity word bank, wherein the commodity word bank includes a plurality of preset commodity evaluation keywords;
including a phrase of the sentence that matches an entry of the commodity word bank in a set of successfully matched commodity evaluation keywords; and
providing the set of successfully matched commodity evaluation keywords to a user interface.
